(19) United States
(12) Patent Application Publication
(10) Pub. No.: US 2025/0308090 A1
(43) Pub. Date: Oct. 2, 2025

(54) VISUALIZATION OF DETECTED DEFECTS

(71) Applicant: Wichita State University, Wichita, KS (US)

(72) Inventors: John Tomblin, Wichita, KS (US); Tharaka Nandakumara, Wichita, KS (US); Waruna Seneviratne, Wichita, KS (US); Varun Sarja, Wichita, KS (US)

(21) Appl. No.: 19/097,278

(22) Filed: Apr. 1, 2025

Related U.S. Application Data
(60) Provisional application No. 63/572,448, filed on Apr. 1, 2024.

(51) Int. Cl. G06T 11/00

(52) U.S. Cl. CPC G06T 11/00; G06T 2200/24

(57) ABSTRACT

In a method of visualizing one or more defects on a part comprises, defect data representative of the one or more defects on the part is obtained by an in-process automated fiber placement manufacturing inspection system. The data is then received by a visualization module. A location on the part is determined for each defect of the one or more defects. One or more laser lines are projected onto the part to indicate the location of at least one defect of the one or more defects. The method can be implemented by a system that uses a laser projection system to project the laser lines on the part and a user device running a visualization app that interfaces with the main software for the in-process automated fiber placement manufacturing inspection system.

### CROSS-REFERENCE TO RELATED APPLICATION

This application claims priority to U.S. Provisional Patent Application No. 63/572,448, filed Apr. 1, 2024, which is hereby incorporated by reference in its entirety.

### STATEMENT REGARDING FEDERALLY SPONSORED RESEARCH OR DEVELOPMENT

This invention was made with government support Award No. FA8650-19-C-5212, awarded by AFRL (Air Force Research Laboratory). The government of the United States has certain rights in the invention.

### FIELD

This disclosure relates generally to inspection systems and, more particularly, to systems and methods for visualizing one or more defects detected via an in-process automated fiber placement (AFP) manufacturing inspection system (IAMIS).

### BACKGROUND

Automated fiber placement (AFP) is a composite manufacturing technique used to fabricate complex advanced air vehicle structures that are lightweight with superior qualities. The AFP process is intricate and complex with various phases of design, process planning, manufacturing, and inspection. The AFP process uses a gantry/robotic system with an attached fiber placement head. The AFP head enables multiple strips of composite material, or tows, to be laid onto a tool surface. Adhesion between the incoming tows and substrate is ensured by using appropriate process conditions such as heating, compaction, and tensioning systems. A series of tows forms a course, courses are then combined to create a ply, and multiple plies create a laminate.

Although AFP has significantly improved the production rate and quality of laminate structures, the integration of multiple disciplines such as robotics, nondestructive inspection (NDI), and processing modeling presents challenges in detecting defects like gaps, overlaps, missing tows, twisted tows, puckers or wrinkles, foreign object debris (FOD). As the tows from multiple spools are laid down, a wide variety of defects may be present. Since these defects can have a significant impact on the structural margin of safety, it is important to detect and repair such defects. Quality assurance through inspections and process controls are essential to ensure that material is laid up and processed according to specification without process-induced defects.

Currently, AFP processes are interrupted after each layer so that the layup can be visually/manually inspected for defects. This manual inspection process can consume 20-70 percent of the total production time, which diminishes the benefits of automation that would otherwise improve the production rate. This makes producing large scale composites increasingly time and cost prohibitive. In addition, manual inspection processes depend heavily on operator skill and training and can be inconsistent and subject to human error. Moreover, due to low contrast between the substrate and incoming tows, visual identification of defects has proven to be difficult. Although thermal imaging, laser profiling, eddy current inspection and other non-destructive testing (NDT) techniques have been employed to ease the difficulty of inspection, improved accuracy and speed of rapid in-process, or in-line, automated inspection is needed.

### SUMMARY

The present disclosure enables visualization of one or more detected defects. In one aspect, a method is provided for visualizing one or more defects on a part. The method includes receiving defect data representative of the defects on the part, determining a location on the part for each defect, and projecting one or more laser lines onto the part to indicate the location of at least one defect.

In another aspect, a defect visualization system is provided for visualizing one or more defects on a part. The defect visualization system includes an in-process non-destructive automated fiber placement inspection device configured to detect the defects on the part, and a laser projection system configured to receive defect data representative of the defects, determine a location on the part for each defect, and project one or more laser lines onto the part to indicate the location of at least one defect.

In yet another aspect, a computer system is provided for visualizing one or more defects on a part. The computer system includes one or more storage media storing instructions, and one or more processors communicatively coupled to the storage media and configured to execute the instructions to implement a detection module configured to detect the defects on the part and generate defect data representative of the defects, and a visualization module configured to receive the defect data, determine a location on the part for each defect, and project one or more laser lines onto the part to indicate the location of at least one defect.

In another aspect, a method of visualizing one or more defects on a part comprises receiving defect data representative of the one or more defects on the part. The data is obtained by an in-process automated fiber placement (AFP) manufacturing inspection system (IAMIS). A location on the part is determined for each defect of the one or more defects. One or more laser lines are projected onto the part to indicate the location of at least one defect of the one or more defects.

In another aspect, a defect visualization system for visualizing one or more defects on a part comprise an in-process automated fiber placement (AFP) manufacturing inspection system (IAMIS) configured to detect the one or more defects. A laser projection system is configured to receive defect data from the IAMIS representative of the one or more defects, determine a location on the part for each defect of the one or more defects, and project one or more laser lines onto the part to indicate the location of at least one defect of the one or more defects.

In another aspect, a computer system for visualizing one or more defects on a part comprises one or more storage media storing instructions. One or more processors are communicatively coupled to the storage media and configured to execute the instructions to implement: a detection module configured to detect the one or more defects in-process during an automated fiber placemen (AFP) process and generate defect data representative of the one or more defects; and a visualization module configured to receive the defect data, determine a location on the part for each defect of the one or more defects, and project one or more laser lines onto the part to indicate the location of at least one defect of the one or more defects.

Other aspects and features of the present disclosure will be in part apparent and in part pointed out herein. This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail below with reference to the attached drawing figures, wherein:

FIG. 1 is a diagram of an example defect visualization system;

FIG. 2 is a picture showing use of the defect visualization system shown in FIG. 1;

FIGS. 3-7 are example screenshots that may be presented during use of the defect visualization system shown in FIG. 1;

FIG. 8 is a picture showing a tooling ball which may be used with the defect visualization system shown in FIG. 1; and

FIG. 9 is a flow chart illustrating a method of using the defect visualization system.

Corresponding reference numbers indicate corresponding parts throughout the drawings.

### DETAILED DESCRIPTION

This disclosure generally pertains to inspection systems and, more particularly, to the visualization of defects detected via an in-process automated fiber placement (AFP) manufacturing inspection system (IAMIS). Additional information about the IAMIS is provided in U.S. patent application Ser. Nos. 18/439,757, 18/444,936, and 18/584,880, each of which is hereby incorporated by reference in its entirety. The IAMIS may be used with AFP systems of the type used to form composite parts by using an automated robotic system including a fiber application head to apply strips of fibers to a molding in strip-by-strip fashion. The strips of fiber are commonly referred to as tape or tows. Commercially, these types of AFP systems are available from Coriolis Composites SAS, Electroimpact Inc., and Mikrosam, for example. Those skilled in the art will recognize that, in comparison with conventional composite manufacturing systems, AFP systems can automate the manufacture of more complex and intricate parts as they allow for a much greater degree of control over how fibers are laid up in the composite.

The examples described herein enable in-situ inspection of defects. To increase AFP production rates to match their potential, the examples described herein include a defect visualization system for use with the IAMIS. The defect visualization system may be used to visualize AFP layup defects. In some examples, the defect visualization system may include a companion app configured to run on a mobile device. The companion app may run in collaboration with the main IAMIS desktop application, for when a user is away from the main application and still wishes to view information for a ply, such as when the user is in an AFP cell examining the part.

Aspects of the present disclosure provide for a computing system that performs one or more operations in an environment including a plurality of devices coupled to each other via a network (e.g., a local area network (LAN), a wide area network (WAN), the internet). The systems and methods described herein may be implemented using computer programming or engineering techniques including computer software, firmware, hardware, or a combination or subset thereof. Unless defined otherwise, all technical and scientific terms used herein have the same meaning as commonly understood by one of ordinary skill in the art to which the present disclosure belongs. Although any methods and materials similar to or equivalent to those described herein can be used in the practice or testing of the present disclosure, some preferred methods and materials are described below.

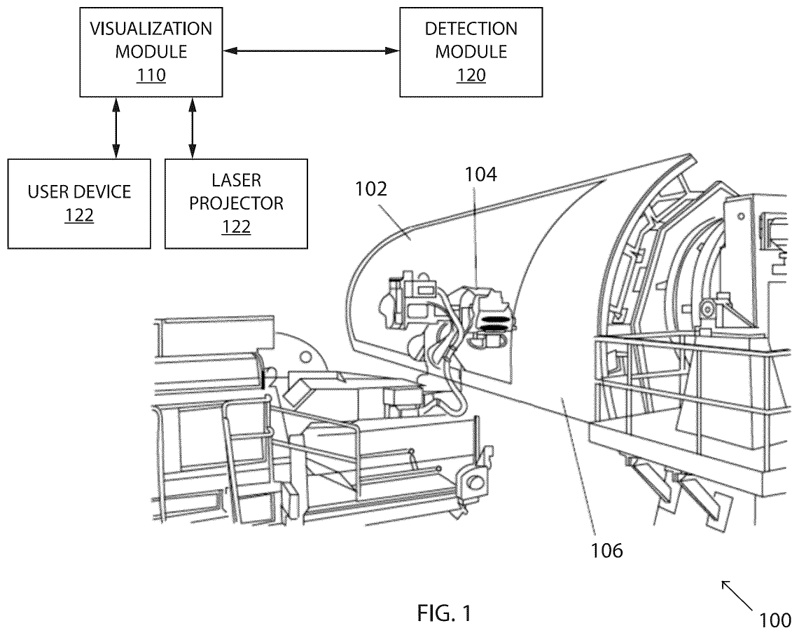

FIG. 1 shows an example defect visualization system 100 for use in visualizing one or more defects on a part 102 constructed by an automated fiber placement (AFP) system 104. As shown in FIG. 1, the part 102 may be constructed on a tool 106 of the AFP system 104. In some examples, the defect visualization system 100 may use an IAMIS Viewer application as developed for the purpose of visualizing defects. For example, the defect visualization system 100 may include a visualization module 110 that imports or receives a defect list generated by a detection module 120 configured to identify or detect one or more defects on the part 102 and determine a defect type, a contour, and/or a location for each of the detected defects. The detection module is connected to a main IAMIS software application 121, which typically runs on a desktop computer located near the AFP system 104. Additional information about the main IAMIS software application 121 is provided in U.S. patent application Ser. No. 18/439,757, which was previously incorporated by reference herein.

The visualization module 110 communicates with a user device 122 to present an image of the part 102 and one or more display objects corresponding to the defects on the image of the part 102. The user device 122 may be or include, for example, one or more of a tablet, a mobile device, and/or a headset. Additionally or alternatively, the visualization module 110 may communicate with a laser projector 124 to project one or more laser lines onto the part 102 to indicate the location of at least one defect. In this manner, a user may easily view the defects on the real-world part 102. In some examples, the visualization module 110 may transmit to the laser projector 124 positional data of the detected defects. An example laser projector 124 that may be used is the Aligned Vision LASERGUIDE2 system.

However, it should be known that other suitable laser projectors may also be used within the present disclosure.

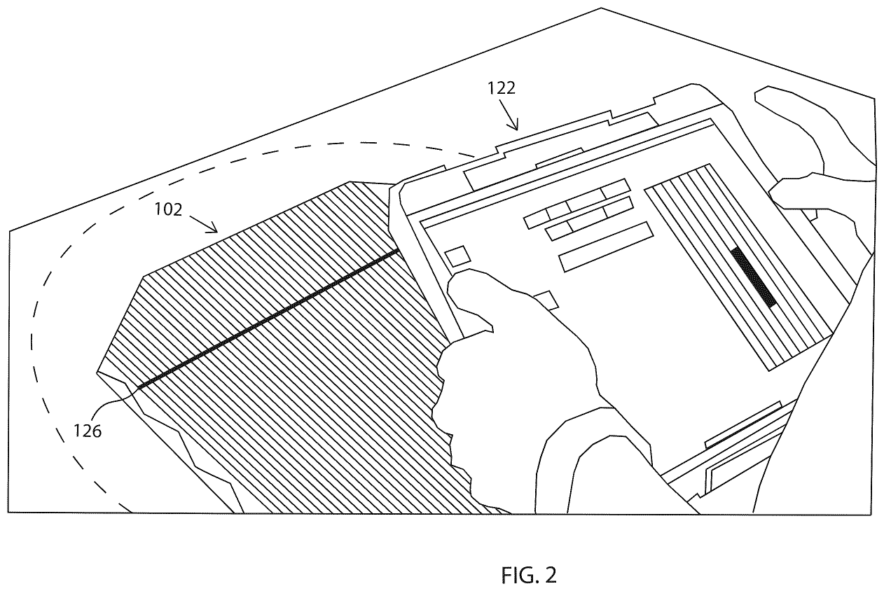

FIG. 2 shows a laser line 126 which may be projected on the part 102 using the laser projector 124 (shown in FIG. 1) and an example user device 122 which may be used to make selections to view defect type, contour, and/or location within individual tapes and plies. The user device 122 may run, for example, a companion app in collaboration with the main IAMIS desktop application to switch between the different selections, such that the laser projector 124 projects one or more laser lines 126 onto the part 102 for indicating or highlighting one or more defects on the part 102. In some examples, the companion app sends a new message to the IAMIS desktop application each time the user makes a selection.

The IAMIS system 100 may use a wireless connection between the user device 122 and the computing device that runs the main IAMIS software application 121. In one or more embodiments, the IAMIS system 100 can transfer data between the main IAMIS software application 121 and the user device 122 with MQ Telemetry Transport (MQTT) protocol. The companion app running on the user device 122 displays defect details for the current ply with defects grouped by tape number and tape images with defect annotations thereon. The user may make selections, changes, and updates through the companion app on the user device 122. Those selections are communicated to the IAMIS main software 121 through a data transfer system.

Regarding defect data transfer, the mobile application establishes a connection to the IAMIS software 121 using MQTT protocol, connecting as a client to the main software server. Both the mobile device application and the IAMIS desktop application 121 may reside on the same network. The server-client configuration enables the server to control message distribution to the client. Upon establishing connection, the client may subscribe to designated topics. Messages transmitted by either client or server include an associated topic. The client may be configured to receive messages that are limited to the topics to which the client has subscribed. This configuration facilitates multiple clients connecting to the server for different purposes and simplifies message handling by associating specific tasks with designated topics.

Following client-server connection, the client receives a message containing current ply information formatted as JSON data. The JSON data may include a ply number, a tape list, and a ply defect list. The defect list may include defect parameters such as defect type, length and width of defect, and a tow number. Selection of a new ply in the main IAMIS software 121 triggers transmission of a new message to the client containing updated ply data. Additional data transmission events may include: (1) change of tape number in the application, whereupon the server transmits the corresponding tape image to the client; (2) update of defect filters either in the companion app or main software, whereupon the tape images are updated and retransmitted; and (3) update of defect filters in either the companion app or main software, triggering message transmission to synchronize filters across all applications.

The laser projector 124 may use different visualization modes to display the location of defect onto the part 102. A first mode may include an outer bounding box representation, and a second mode may include a defect contour representation. The bounding box may be used when displaying a large number of defects over an area of the part. It may be easier for the operator to view the defects in a bounding box with only four linear projections, in contrast to the contour representation which could require thousands of linear projections if many defects are detected. FIG. 2 shows a defect contour representation with a projected laser line 126 on the part 102. In this example, the operator has selected a particular defect type, and the defect on the part 102 is being highlighted by the laser line 126.

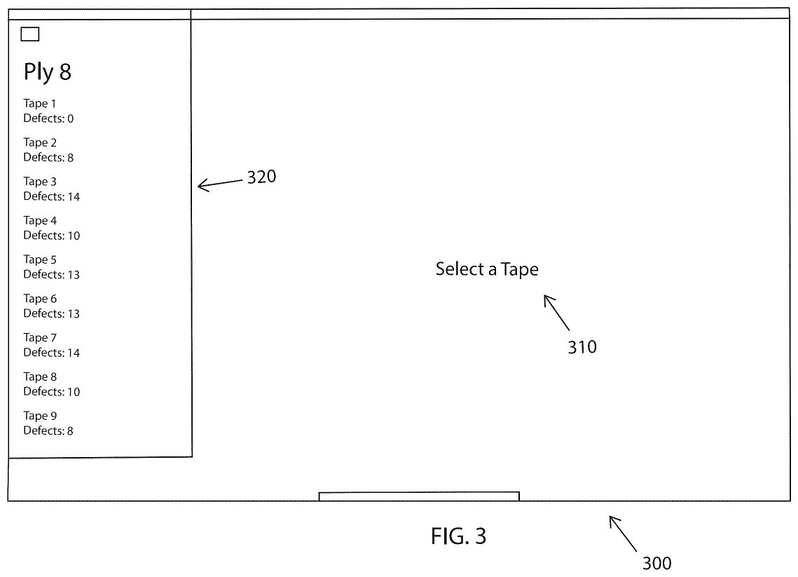

FIGS. 3-7 show various screenshots of a visualization companion application that may be presented to a user of the defect visualization system 100 (shown in FIG. 1). The screenshots may be shown, for example, on the user device 122 (shown in FIG. 2) and/or another computing device (e.g., desktop computer). The companion app user interface includes a main tape view, a sidebar, and a settings page.

FIG. 3 shows a screenshot 300 including a main panel 310 displaying a prompt which instructs the user to select a tape and a side panel 320 displaying a list of tapes from which the user may select a tape. The side panel 320 may display information for each tape in the list of tapes. The information shown in the side panel 320 may include, for example, a name (e.g., “Tape 1”) and a number of defects (e.g., a defect count) associated with each tape. The side panel 320 allows the user to navigate to each tape on the ply by selecting each tape. Selecting a tape in the side panel 320 updates the main panel 310 to display the defect information for the selected tape. The main panel 310 is split into two views, one view contains a list of defects on a selected tape and the other view has an annotated image of the selected tape.

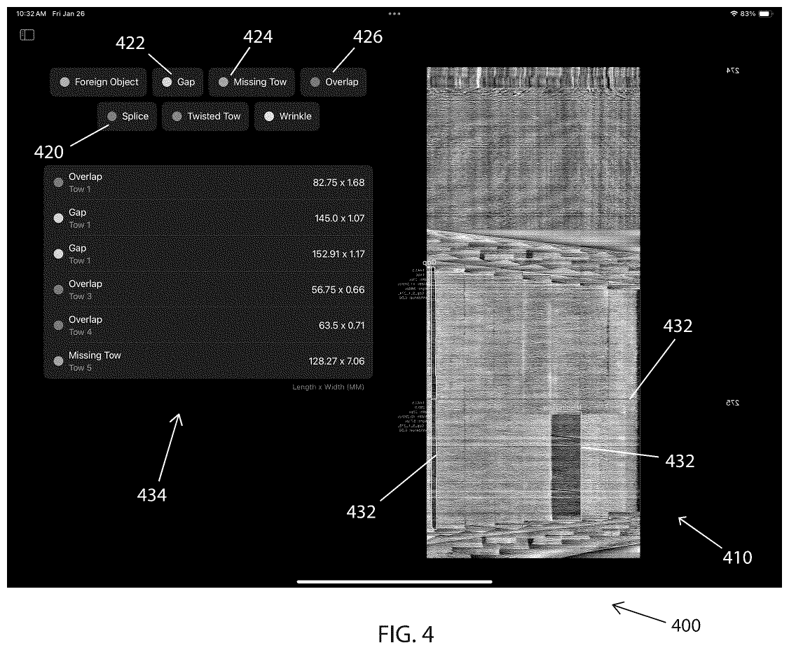

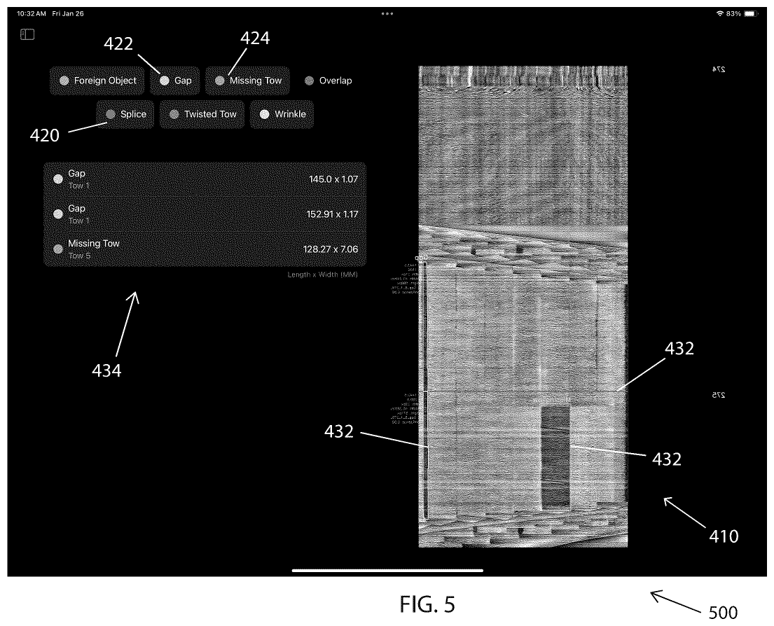

FIG. 4 shows a screenshot 400 and FIG. 5 shows a screenshot 500, each including a main panel 410 displaying an image of a tape and a filter group 420 displaying one or more defect filters. In some examples, the tape shown in FIGS. 4 and 5 may correspond to the tape selected from the list of tapes shown in FIG. 3. The defect filters shown in the filter group 420 may allow the user to selectively visualize one or more defects based on a defect type, such as Foreign Object Debris (FOD), Gap, Missing Tow, Overlap, Splice, Twisted Tow, or Wrinkle. For example, the defect filters selected in FIG. 4 may include Gap 422, Missing Tow 424, and Overlap 426, and the defect filters selected in FIG. 5 may include Gap 422 and Missing Tow 424. In this manner, the user may toggle through the different types of detected defects.

The main panel 410 is configured to display one or more display objects 432 in or on the image of the tape that correspond to the defects on the real-world counterpart (e.g., part 102) and that are of the type(s) associated with the selected defect filters. For example, the display objects 432 shown in FIG. 4 may be used to indicate or highlight gaps, missing tows, and overlaps, and the display objects 432 shown in FIG. 5 may be used to indicate or highlight gaps and missing tows but not overlaps. In some examples, a list of defects 434 is displayed, including one or more defects corresponding to the display objects 432 shown in the main panel 410. For example, the list of defects 434 shown in FIG. 4 includes six defects (e.g., two gaps, one missing tow, and three overlaps), and the list of defects 434 shown in FIG. 5 includes three defects (e.g., two gaps and one missing tow). As shown in FIGS. 4 and 5, the defect filters (e.g., Gap 422, Missing Tow 424, and Overlap 426), display objects 432, and/or list of defects 434 may be color coordinated (e.g., yellow for gaps, green for missing tows, and/or blue for overlaps). The illustrated defect list 434 displays the type of defect, defect size, defect repair status, and the tow number for each defect. If a defect is repaired by an operator, the operator may swipe the defect in the defect list 444 to reveal a button which is used to mark the defect as repaired (not shown).

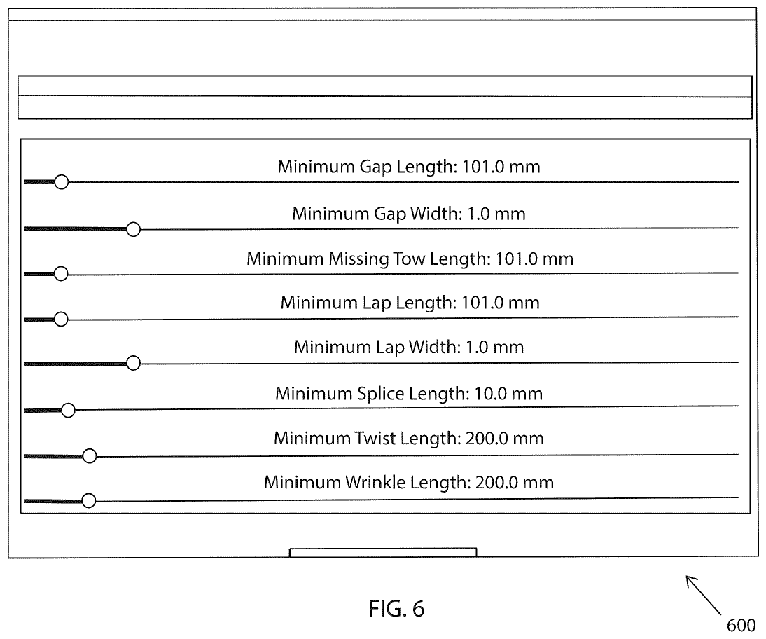

FIG. 6 shows a screenshot 600 of a settings page including a plurality of defect filters which allow the user to selectively visualize one or more defects based on a defect size. For example, the user may use one or more sliders to selectively filter out one or more display objects 432 (shown in FIGS. 4 and 5) based on a length or width of the defect on the real-world counterpart (e.g., part 102). In this manner, the main panel 410 may be configured to display one or more display objects 432 in or on the image of the tape that correspond to the defects on the real-world counterpart (e.g., part 102), that are of the type(s) associated with the selected defect filters, and that are of the size(s) associated with the selected defect filters.

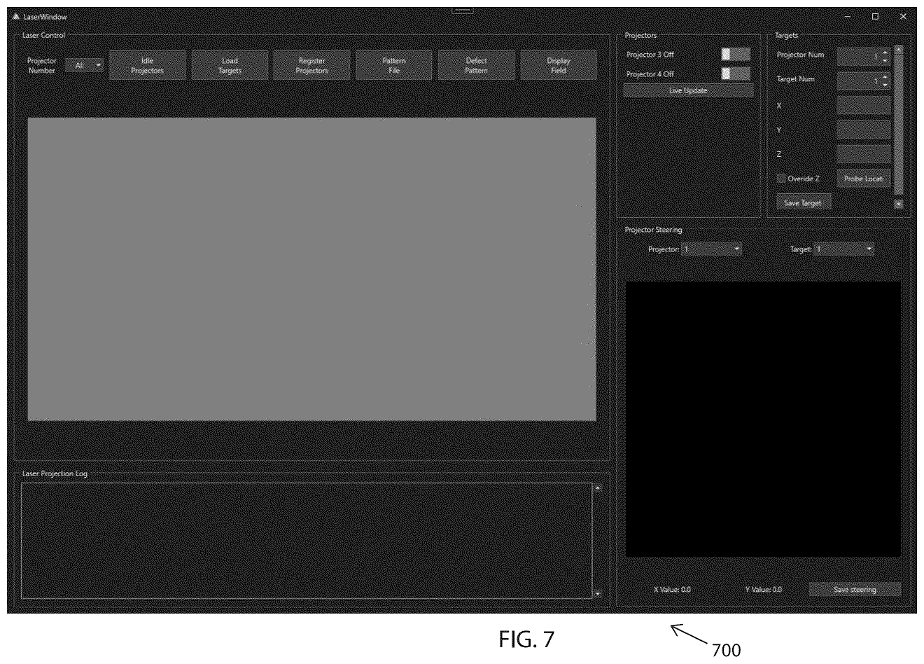

FIG. 7 shows a screenshot 700 including a laser projector window which may be used to communicate with a laser projector 124 (shown in FIG. 1) to project one or more laser lines 126 (shown in FIG. 2) onto the part 102 to indicate the location of at least one defect. The laser projector window shown in FIG. 7 includes one or more laser control buttons, toggle and status indicators for each projector being used, and a panel which enables user control of each projector. The panel may be used, for example, to set a target destination for a particular projector using the projector number, a target number, and/or X, Y, and Z coordinates. At least some of the configurations within the laser projector window may be saved, such as the projector steering and target destination. In some examples, the laser projector window may include a laser projection log which provides a user with laser projector information describing projector movements, commands, and any feedback received from the laser projector 124.

The laser visualization patterns may automatically be generated utilizing three-dimensional data that resides in the main IAMIS software application 121. Each displayable defect may have at least one corresponding contour subjected to a coordinate transformation to convert said contour to one of a Z-up, Y-up, or X-up coordinate system. The coordinate transformation may be implemented to accommodate different types of AFP systems with different coordinate systems. Upon completion of the transformation, the laser visualization pattern file is transmitted to the laser projector 124.

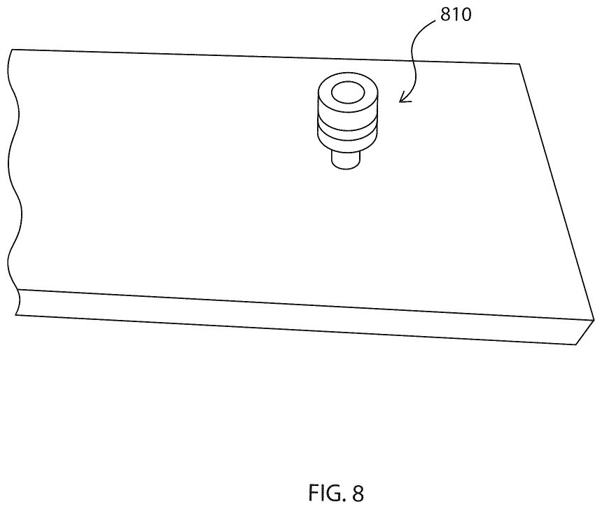

FIG. 8 shows an example position reference marker 610 (e.g., a retroreflector) inserted in a tooling ball holder which may be used to provide a precise reference point for use in determining positional data of the defects and transforming the data to align the defects onto the part 102. In some examples, the visualization module 110 (shown in FIG. 1) may determine a location of the position reference marker 610 using a target file including region location information. In an embodiment, a plurality of position reference markers 610 may be installed within the tool ball holders of the tool 106 (FIG. 1). A target file is created that defines the three-dimensional spatial coordinates of the position reference markers 610 and correlates those coordinates with AFP program data that has previously been loaded into the IAMIS software 121. To establish the target file, the laser projector beam is manually directed to focus on each position reference marker 610 to determine the spatial coordinates of each position reference marker. The laser projector may use the target file to compute a transformation matrix for converting three-dimensional coordinates to angular coordinates. The laser projector may include two mirrors mounted on galvanometers, configured to direct a laser point throughout the three-dimensional space. The laser point steering occurs at a frequency exceeding human visual perception, thereby creating the appearance of a continuous line projected upon the surface of the part.

The companion app provides user-selectable filters and parameters whereby a user may direct the laser projector to selectively illuminate defects according to defect type, tape identification, or repairable defect thresholds, enabling defect visualization according to user-specified criteria. For example, a user may select defects that have been detected and quantified by the IAMIS software as a repairable defect. The laser projector may project laser lines or bounding boxes to highlight the defects requiring repairs. Once the repairs have been completed, the user may record the defect repairs in the companion app which transmits the repair data to the main IAMIS application. The records of repairs become a part of the digital twin data generated by the main IAMIS application.

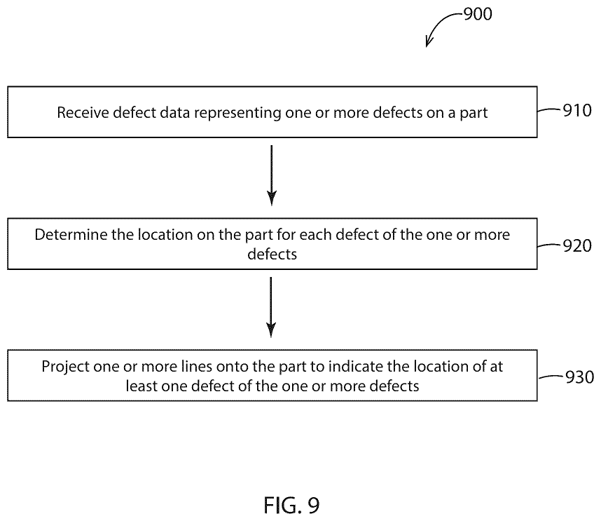

Referring now to FIG. 9, the method of visualizing one or more defects on a part 102 is broadly described herein, comprising three steps: (1) receiving defect data representing one or more defects on a part 102, (2) determining the location on the part 102 for each defect of the one or more defects, and (3) projecting one or more lines onto the part 102 to indicate the location of at least one defect of the one or more defects. To initiate the program configured to visualize one or more defects on a part 102, the method may include scanning a machine-readable identification code using a user device 122 configured with the companion app. The identification code may be a QR code, a barcode, or similar type of machine-readable code, including but not limited to: Data Matrix, Aztec, Trillcode, QuickMark, ShotCode, and mCode, which may be unique to each part 102 being laid up and/or may be configured to lead a user to retrieve defect data for the corresponding part 102. Additionally, the user device 122 is in communication with the visualization module 110, wherein the visualization module 110 is configured to receive the defect data generated by the detection module 120. The detection module 120 is configured to identify or detect one or more defects on the part 102 and determine a defect type, a contour, and/or a location for each of the detected defects.

Referring still to FIG. 9, the flow chart depicting the method 900 describes visualizing one or more defects on a part 102 using laser projectors 124 to identify defect data, of the one or more defects on the part 102 may be retrieved through the visualization module 110. This is described at step 910, wherein the defect data may be retrieved through a .txt file containing all of the detected defect information, including defect type and defect contour data points. The defect type can be at least one of a gap, overlap, splice, twisted tow, missing tow, or foreign object debris (FOD). At step 920, the location of each defect on the part 102 is determined using the received defect data representing one or more defects on the part 102. One example for determining the location of each defect on the respective part 102 is through the tooling ball 810, wherein the tooling ball 810 is configured to provide a precise reference point for use in determining positional data of the defects and transforming the data to align the defects onto the part 102. Each defect may then be visualized using a user device 122 and/or laser projector 124. In some examples, a display object 432 for each defect may be generated and presented using the user device 122 so that the display object 432 appears in alignment with the location of the corresponding defect on the part 102. Additionally, or alternatively, one or more lines may be projected onto the part 102 to allow the user to more precisely locate and visualize the defect while standing in the room with the part 102, as described at step 930.

In operation, processors, computers and/or servers may execute the processor-executable instructions (e.g., software, firmware, and/or hardware) such as those illustrated herein to implement aspects of the invention. The defect visualization system 100 may be used to visualize one or more defects on a part 102. In some examples, the defect visualization system 100 may include a visualization module 110 configured to receive defect data representative of one or more defects on the part 102, generate one or more display objects 432 corresponding to the one or more defects on the part 102, and present the one or more display objects 432 on the user device 122 so that the one or more display objects 432 appear in alignment with the one or more defects on the part 102. For example, the visualization module 110 may generate one or more display objects 432 and position the display objects 432 on an image of the part 102 shown on a user device 122. For another example, the visualization module 110 may project one or more laser lines 126 onto the real-world part 102 using a laser projector 124.

In some examples, a computing system (e.g., visualization module 110, detection module 120, user device 122, laser projector 124) may be configured to perform one or more computing operations described herein. The computing system may include a processor, a system memory, and a bus coupling various system components including the system memory to the processor.

The processor is configured to perform general computing functions and process data and instructions to perform one or more operations and/or provide other functionality described herein. For example, the processor may access the system memory to read data and instructions from and/or write data and instructions to the system memory for use in executing one or more computer-executable instructions. In this manner, the processor may be programmed to execute any aspect of the software components described herein. In some examples, the processor may be or include any quantity of processing units including a central processing unit, a graphics processing unit, a field-programmable gate array (FPGA), a digital signal processor (DSP), or other hardware logic components including, without limitation, an Application-Specific Integrated Circuit (ASIC), Application-Specific Standard Product (ASSP), System-on-a-Chip System (SOC), Complex Programmable Logic Device (CPLD), etc.

The system memory includes any combination of computer-readable media that may be accessed by the processor. In some examples, the system memory includes a read-only memory (ROM) which stores instructions for executing basic functions and a random access memory (RAM) which temporarily stores data and instructions for actively used programs. For example, the RAM may be used to host or store display objects 432, as well as one or more software components for controlling the visualization module 110, detection module 120, user device 122, and/or laser projector 124.

Computer-readable media includes both communication media and computer storage media. Communication media typically embody computer-readable instructions, data structures, program modules, or other data in a modulated data signal, such as a carrier wave or other transport mechanism. The term “modulated data signal” means a signal that has one or more of its characteristics set or changed in a manner as to encode information in the signal. By way of example, and not limitation, communication media includes wired media, such as a wired network or direct-wired connection, and wireless media, such as acoustic, radio frequency, and infrared media.

In contrast, computer storage media include tangible forms of media that can store information such as computer-readable instructions, data structures, program modules, or other data. By way of example, and not limitation, computer storage media includes ROM, RAM, hard disk drives (HDDs), solid-state drives (SSDs), external hard drives, flash drives, optical storage media (e.g., compact discs (CDs), digital versatile discs (DVDs), and magnetic storage media (e.g., tape drives). For purposes of the present disclosure, computer storage media is mutually exclusive to communication media and excludes waves, signals, and other transitory or intangible forms of media.

It should be appreciated that the software components described herein, when loaded into the processor and executed, may transform the processor and the overall computing system from a general-purpose computing system into a special-purpose computing system customized to facilitate the functionality described herein. More specifically, the computer-executable instructions contained within the software components described herein transform the processor to operate or function as a finite-state machine by specifying how the processor transitions between states, thereby transforming the transistors or other discrete circuit elements constituting the processor.

Encoding the software components described herein may also transform the physical structure of the computer-readable media described herein. The specific transformation of physical structure may depend on various factors, in different implementations of the present disclosure. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the transistors, capacitors, or other discrete circuit elements constituting the semiconductor-based memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In some examples, the computing system includes a mass storage device coupled to the processor for hosting or storing data and instructions, such as an operating system, one or more programs (e.g., IAMIS desktop application, companion application), and/or data. One of ordinary skill in the art would understand that copies of at least some data and/or instructions hosted or stored in the mass storage device may be at least temporarily stored in the system memory to enable the computing system to function as described herein.

The computing system may connect to a network through a network interface unit connected to the bus. In this manner, the computing system may operate in a networked environment in which the computing system may use one or more remote devices to host or store at least some data and/or to execute at least some instructions. Computer communication between computing systems can be a network transfer, a file transfer, an applet transfer, an email, a hypertext transfer protocol (HTTP) transfer, and so on.

In some examples, the computing system may include one or more input/output (I/O) controllers that facilitate communication and data transfer between the processor and one or more I/O devices configured to provide input and/or output capabilities. For example, a user may enter commands and information into the computing system using one or more input devices, such as a keyboard, pointing device (e.g., mouse, trackball, touch pad, stylus), microphone, camera, scanner, accelerometer, and the like. Additionally or alternatively, the computing system may present various forms of information, such as text, images, audio, video, alerts, and the like, using one or more output devices, such as a monitor, projector, printer, speaker, actuator, and the like. In some examples, the output device may be integrated with the input device (e.g., in a touchscreen panel or in a controller including a vibrating component).

While some examples are illustrated and described herein with reference to the computing system being, including, or being included in the visualization module 110, detection module 120, user device 122, and/or laser projector 124, aspects of the present disclosure are operable with any computing system that can execute computer-executable instructions to implement the operations and functionality associated with the computing system. For example, aspects of the invention may be operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Examples of the aspects of the present disclosure may be described in the general context of data and/or processor-executable instructions, such as program modules, stored one or more tangible, non-transitory storage media and executed by one or more processors or other devices. For purposes of illustration, programs and other executable program components may be shown as discrete blocks. It is recognized, however, that such programs and components reside at various times in different storage components of a computing device and are executed by a data processor(s) of the device. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

Examples may be implemented with processor-executable instructions. The processor-executable instructions may be organized into one or more processor-executable components or modules on a tangible processor readable storage medium. Also, examples may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

While the aspects of the present disclosure have been described in terms of various examples with their associated operations, a person skilled in the art would appreciate that a combination of operations from any number of different examples is also within the scope of the aspects of the present disclosure.

What is claimed is:

1. A method of visualizing one or more defects on a part, the method comprising: receiving defect data representative of the one or more defects on the part, the data being obtained by an in-process automated fiber placement (AFP) manufacturing inspection system (IAMIS);
determining a location on the part for each defect of the one or more defects; and
projecting one or more laser lines onto the part to indicate the location of at least one defect of the one or more defects.

2. The method of claim 1, further comprising presenting an image of the part and one or more display objects corresponding to the one or more defects on the image of the part.

3. The method of claim 2, further comprising presenting a filter group displaying one or more defect filters.

4. The method of claim 3, wherein the one or more defect filters include defect filters based on defect type.

5. The method of claim 4, further comprising receiving user input selecting one of the defect filters based on defect type and wherein said projecting the one or more laser lines comprises projecting laser lines to indicate the location of only defects of the selected type.

6. The method of claim 4, wherein the defect filters based on defect type include a defect filter for at least two of: Foreign Object Debris (FOD), Gap, Missing Tow, Overlap, Splice, Twisted Tow, or Wrinkle.

7. A defect visualization system for visualizing one or more defects on a part, the defect visualization system comprising:
an in-process automated fiber placement (AFP) manufacturing inspection system (IAMIS) configured to detect the one or more defects; and
a laser projection system configured to receive defect data from the IAMIS representative of the one or more defects, determine a location on the part for each defect of the one or more defects, and project one or more laser lines onto the part to indicate the location of at least one defect of the one or more defects.

8. The system of claim 7, further comprising a user device configured to present an image of the part and one or more display objects corresponding to the one or more defects on the image of the part.

9. The system of claim 8, wherein the user device is configured to present a filter group displaying one or more defect filters.

10. The system of claim 9, wherein the one or more defect filters include defect filters based on defect type.

11. The system of claim 10, wherein the user device is configured to receive user input selecting one of the defect filters based on defect type and in response to cause the laser projection system to project laser lines to indicate the location of only defects of the selected type.

12. The system of claim 10, wherein the defect filters based on defect type include a defect filter for at least two of: Foreign Object Debris (FOD), Gap, Missing Tow, Overlap, Splice, Twisted Tow, or Wrinkle.

13. A computer system for visualizing one or more defects on a part, the computer system comprising:
one or more storage media storing instructions; and
one or more processors communicatively coupled to the storage media and configured to execute the instructions to implement:
a detection module configured to detect the one or more defects in-process during an automated fiber placemen (AFP) process and generate defect data representative of the one or more defects; and
a visualization module configured to receive the defect data, determine a location on the part for each defect of the one or more defects, and project one or more laser lines onto the part to indicate the location of at least one defect of the one or more defects.

14. The computer system for of claim 5, wherein the visualization module is configured to present an image of the part and one or more display objects corresponding to the one or more defects on the image of the part.

15. The computer system of claim 14, wherein the visualization module is configured for presenting a filter group displaying one or more defect filters.

16. The computer system of claim 15, wherein the one or more defect filters include defect filters based on defect type.

17. The computer system of claim 16, wherein the visualization module is configured to receive user input selecting one of the defect filters based on defect type and responsively project laser lines to indicate the location of only defects of the selected type.

18. The computer system of claim 16, wherein the defect filters based on defect type include a defect filter for at least two of: Foreign Object Debris (FOD), Gap, Missing Tow, Overlap, Splice, Twisted Tow, or Wrinkle.
